(19) United States
(12) Patent Application Publication
(10) Pub. No.: US 2006/0206643 A1
(43) Pub. Date: Sep. 14, 2006

(54) Computer switch assemblies

(76) Inventors: Richard Tran, Santa Ana, CA (US); Nancy Tran, Santa Ana, CA (US)

Correspondence Address: DRUMMOND & DUCKWORTH, Suite 500, 4590 MacArthur Blvd., Newport Beach, CA, 92660, US

(21) Appl. No.: 11/356,810

(22) Filed: Feb. 17, 2006

Related U.S. Application Data
(63) Continuation-in-part of application No. 10/808,766, filed on Mar. 24, 2004.

(51) Int. Cl. G06F 13/00

(52) U.S. Cl. 710/100

(57) ABSTRACT

A computer system is provided including a variety of switch components for controlling the selective activation and deactivation of the computer systems' memory storage devices, network system and interface peripheral devices. The switching components may include a switch box having one or more switches for controlling activation and deactivation of various computer components. The switch components may also include a bracket assembly having an input port, output port and an intermediate manual switch for controlling the communication between a network and a computer's processor. The bracket assembly and switch box may also be constructed to control the transmission or restriction of power or data signals to a memory storage device or may control the transmission of power or data signals to one or more interface peripheral ports.

### RELATED APPLICATIONS

This application is a continuation-in-part of pending U.S. application Ser. No. 10/808,766, filed Mar. 24, 2004.

### BACKGROUND OF THE INVENTION

The present invention relates to computer processing systems. More particularly, the present invention relates to protection devices for enabling and disabling network systems and memory storage devices within a computer system so as to protect against unintentional loading or downloading of information to and from a computer. As used herein, the term “computer memory device” is intended to have its broadest meaning to include any known or anticipated structure for storing information within a computer system. Present memory storage devices include hard drives, floppy drives, CD ROMs, Zip™ drives, etc.

The development of personal computers and mainframe computers experienced considerable growth during the 1970s. These computers were mostly invulnerable to improper access since they were installed in high security environments or provided limited access to unauthorized personnel. However, during the 1980s and 1990s, the networking of computers, and particularly personal computers, greatly contributed to computer system vulnerability. This vulnerability has resulted in malicious codes, typically referred to as computer viruses, being transmitted into and out of computer systems without authorization. The virus propagates itself and spreads wherever it can gain access through an interconnected computer system. Where a computer containing a virus is connected to the Internet, the virus can be transmitted virtually anywhere. Many of these viruses travel to all active computer drives and from there corrupt or destroy data while transmitting themselves to those listed on the computer users' email address lists. This has resulted in billions of dollars in losses worldwide.

A computer system memory storage device is the component most vulnerable to be attacked by a virus. Memory storage devices are areas where all “data” reside which include all user application data (for example data base information, financial information, institutional records, etc.) all application software programs, and even the operating system software itself. A single incident of contamination by a virus may totally erase or render the storage device useless to the point that even the most knowledgeable programmer is unable to recover data.

An additional problem encountered by interconnecting computer systems using networks, such as the Internet, wide area networks (WAN) and local area networks (LAN), is that memory storage devices become vulnerable to unauthorized or undesirable theft of information. For example, computer hackers have “hacked” their way into various computer systems and stolen significant amounts of information. Again, this has resulted in millions, if not billions, of dollars worth of losses.

The advent of file-sharing Internet sites including Napster™ and Kazaa™ have resulted in persons intentionally and unintentionally sharing, in other words downloading, their files to unknown persons all over the Internet. Again, it would be desirable to control the dissemination of such information.

Many persons include more than one operating system on their computer and many programs may be incompatible. Moreover, there has been an increasing demand for storage space on computers. This incompatibility between operating systems and programs and increased demand for storage has resulted in persons mounting more than one storage device within a single central processing unit. As it has become more cost effective to mount additional storage devices, virtually all computer systems have multiple memory storage devices including combinations of hard drive, floppy drives, CD ROMs, etc.

The addition of more storage devices, however, does not protect memory from corruption if the computer comes under attack by a virus. The only known way of protecting a user's software programs, data and documents is by storing a copy on a secondary storage device, such as a second hard drive, and then taking the secondary memory storage device out of the data stream.

When such a companion or secondary memory storage device is used on a single computer, it is desirable to be able to selectively isolate the memory storage device or devices from outside influence without inhibiting the computer-user's ability to access information from the secondary drive as quickly and as efficiently as needed. Thus, there is a significant need for a system that not only isolates a memory storage device from Internet corruption, but also isolates a memory storage device from conventional networks for providing confidentiality and protection against viruses, hacking and file-sharing.

In light of the relatively recent origin of the problems, there have been few innovators in the computer field that have proposed protection which is both effective and affordable for the average user. Virus protection is typically provided by software programs such as those available from McAfee™, Norton™ and others which focus on detecting viruses being spread on an ongoing basis. Unfortunately, these virus protection programs are not infallible and they do not provide protection against others downloading one's files without authorization.

An additional attempt to protect memory storage devices from unwanted access is to provide the storage device with some kind of ability for turning off the “read” or “write” function. For example, many tape and disc storage devices offer a switch for turning off the “write” function. Large mainframe computers have capabilities for turning on and off individual memory storage devices such as magnetic tape or the like.

Unfortunately, very limited attempts have been made to protect the memory storage devices and network access to individual personal computers. One such attempt is disclosed in U.S. Publication No. 2003/1077403. This reference describes a switching system which will activate and deactivate the power supply to individual storage devices such as hard drives and CD-ROMs. This construction provides significant protection to a memory storage device as access is completely eliminated when the power supply to the memory storage device is disconnected. Unfortunately, however, each time the power is deactivated and reactivated to the memory storage device, the unit must reboot taking an undesirable amount of time. It would therefore be desirable to provide protection to a memory storage device without necessarily deactivating the power to it.

Still additional attempts have been made to protect computer systems by selectively providing and disabling access to networks. For example, U.S. Pat. No. 5,894,551 describes a switching system for the connection between the network and the CPU's network card. Unfortunately, the switching system is difficult to retrofit into a preexisting personal computer system.

Thus, there is a significant need for a computer system which provides protection to the system's hard drives and network access. Moreover, there is a need for a security system that is inexpensive and can be incorporated as an after-market unit into personal computer systems.

### SUMMARY OF THE INVENTION

Briefly, in accordance with the invention, I provide a computer system including a switch box for selectively controlling the power supply and data transmission to and from a computer memory storage device. I also provide a switching system for selectively controlling the flow of information from a network to a computer's processing system.

The computer system includes a computer processing unit, monitor, and input devices such as a keyboard and mouse. Within the computer's housing, a power supply, processor and memory storage devices are provided. In addition to these traditional components, the computer system of the present invention includes a switch box which controls the operation of one or more memory storage devices within the computer housing. The switch box includes a housing structured to mount within the traditional CPU tower. More particularly, the face of a CPU tower is usually provided with a plurality of bays for the mounting of externally accessible peripherals such as a CD-ROM, DVD reader/writer, and a floppy disk drive. The switch box housing of the present invention is constructed to reside within one of these bays for convenient access by the computer user and simplistic integration into the central processing unit. The switch box includes a plurality of electrical on/off switches, which are preferably push-button switches mounted to the switch box's faceplate. As explained in greater detail below, the push-button switches control the power supplied to individual memory storage devices and control the transmission of commands to the memory storage device so as to enable or disable unauthorized access to the memory storage device. In a preferred embodiment, the switch box includes a total of six switches. The six switches are separated into three pairs with each pair controlling both the power and data supply of three individual memory storage devices.

A preferred switch box includes at least one input power connector which electrically connects via a power cable to the CPU's power supply. In a preferred embodiment, the switch box includes two input power connectors, both of which are connected by power cables to the power supply, to provide redundancy. In accordance with most present day computer systems, the power connectors, and corresponding power cables, include a 12 volt input, a 5 volt input and two ground paths.

The switch box of the present invention also includes output power connectors electrically connected to the input power connectors. The power supplied to the output power connectors is controlled by the corresponding switches positioned on the switch box face plate which are electrically connected in series between the input and output power connectors. More particularly, the output power connectors electrically connect to the CPU's power supply through the power cables, switch box input connectors and the switch box's internal wiring. The output power connector, in turn, connects to individual memory storage devices. Power supplied to the memory storage device is controlled using a corresponding switch so that the memory storage device can be activated and deactivated as desired by the computer's user.

In addition to power control, the switch box provides control over the transmission of data to and from a memory storage device. Computer systems include a data cable which connects memory storage devices to the computer's processor. These signal cables typically include dozens of wires and a corresponding number of pins or sockets within electrical connectors. For example, most memory devices connect to the processor using a 40 channel “IDE” cable. Typically, one of the wires and signal cables, and corresponding pins or sockets, is dedicated to transmitting command signals from the processor to the memory storage device. In standard personal computers, this channel is referred to as the “interrupt” channel and is typically provided through pin number 31 in the IDE cable which connects the computer's processor to a hard disk drive.

It is a primary object of the present invention to provide a switchable control to enable or disable the transmission of the interrupt channel from the processor to the memory storage device. To this end, the switch box includes one or more switches which electrically open or close the interrupt channel. These “signal” switches are electrically connected in series with the interrupt channel. To this end, preferably a traditional IDE cable connector is modified to allow 39 of the 40 channels to be connected directly from the processor to the memory storage device through the IDE cable. However, in a preferred embodiment of the invention, the IDE cable connector mating to the memory storage device is modified so that signals transmitted from the processor through the interrupt channel into pin number 31 are diverted by a separate signal cable to the switch box of the present invention. The interrupt signals are then transmitted through one of the switches and directed back to the IDE cable pin 31 for transmission into the memory storage device. Provision of the switch in series with the interrupt channel allows for the computer user to selectively enable or disable the interrupt channel. With the interrupt channel disabled, in other words in an open condition, the computer processor cannot transmit signals to the memory storage device, resulting in the memory storage device being unable to store information or download information. In other words, placing the interrupt channel in a disabled condition makes the memory storage device completely inaccessible. However, retriggering the switch to a closed position allows signals to be transmitted between the memory storage device and processor.

In addition to a subsystem for controlling the power and signals to a hard drive, the computer system of the present invention preferably includes a switching system for controlling the connection between a network, such as a LAN, WAN or Internet network, with the computer's central processing unit. For purposes of describing the computer system of the present invention, the central processing unit includes any network cards utilized by the computer.

The computer system includes a network port located on the rear of the computer's housing which may be a traditional female connector electrically coupled to the computer's network card. To control access to a network, the computer system includes a bracket assembly forming a portion of the rear of the computer's housing. The bracket assembly includes an input port and an output port. The terms “input” and “output” are used for simplicity because, as understood by those skilled in the art, both the input and output ports transmit signals in both directions. Preferably, both the input port and output port are mounted to the bracket to face exterior to the computer's housing so as to be easily accessible. The input port and output port are electrically coupled except for an intermediate switch which selectively provides an open circuit or closed circuit for permitting or disabling the electrical connection between the input port and output port.

The intermediate switch is preferably a manual switch which may be located either upon the computer's housing or exterior to the computer's housing. In a first embodiment, the bracket assembly includes a “switch” port mounted upon the housing exterior for connecting to a cable traveling to an exterior switch. Signals traveling from the bracket assembly's input port are routed exterior to the computer's housing to the switch and then routed back through the cable to the bracket assembly's output port. Alternatively, the switch may be mounted to the computer's housing with the manual lever, button or other manipulated device being accessible exterior to the housing. For this embodiment, signals traveling from the bracket assembly's input port are routed interior to the computer's housing to the switch and then routed back through the cable to the bracket assembly's output port.

In addition, the network switching system includes a wire harness including a cable connecting the network to the bracket assembly's input port and a relay cable for connecting the bracket assembly's output port to the computer's network port. Instead of network communications being transmitted directly from the network to the network port, the signals are rerouted through the bracket assembly's input port, manual switch and output port, and then routed to the computer's network port. Access to the network is then controlled by simple manual manipulation of the switch to create an open or closed circuit, thereby enabling or disabling access by the computer to the network.

The manual switch may also control the “interrupt” channel of a selected hard drive. As explained above, each hard drive can be selectively controlled by selectively enabling or disabling the transmission of the “interrupt” channel typically found on pin number 31 of an IDE cable. The signal is rerouted through a signal cable to the manual switch and routed back to the IDE cable. Thus, for this embodiment of the invention, activation of the switch provides an open or closed condition in the interrupt channel thereby selectively activating or deactivating a hard drive, as well as corresponding selective activation or deactivation of the network system.

In still an additional embodiment of the invention, the bracket assembly includes an input power connector for receiving power from the power supply and an output power connector for routing power to one of the computer's hard drives. Of course, cables are provided for routing power to the input connector and for transmitting it from the bracket assembly's output power connector to the hard drive. Coupled intermediate to the input power connector and output power connector, the bracket assembly includes a bracket assembly power switch for selectively enabling and disabling the transmission of power to the particular hard drive.

Where the computer system of the present invention includes a manual switch that controls signal to both a network and hard drive, and a bracket assembly switch for controlling power to a hard drive, the switch box of the present invention may not be needed. For example, where the computer user does not require control of multiple drives, such as where sensitive data and network use is limited to a single hard drive, signal control and power control of an alternate hard drive may not be required. In such a circumstance, the switch box of the present invention for controlling signal and power of multiple hard drives may be eliminated.

In an additional preferred embodiment, the computer system includes both a switch assembly and a switch box. The switch assembly includes a bracket and a switch controller for controlling the activation and deactivation of a network and the activation and deactivation of an interface peripheral port, such as a Universal Serial Bus (“USB”) port. Meanwhile, the switch box includes a control switch for controlling activation and deactivation of a memory device, such as a hard drive, a peripheral switch for controlling activation and deactivation of an additional interface peripheral device, and a network switch for controlling activation and deactivation of the network.

The combination of power and signal enable-disable of the present invention provides security to a computer's network, memory storage devices and interface peripheral devices that was previously unavailable.

Therefore, it is an object of the present invention to provide a switch box which provides added security to a computer system.

It is an additional object of the present invention to provide a switch box which is inexpensive to manufacture, easy to install and convenient to use.

It is still an additional object of the present invention to provide a bracket assembly and switch system for controlling computer communication to and from a network.

It is still an additional object of the present invention to provide a bracket assembly and switch system for controlling signal and power transmission of a computer's hard drive.

It is still an additional object of the present invention to provide manual switching components for controlling activation and deactivation of interface peripheral components.

These and other specific objects and advantages of the invention will be apparent to those skilled in the art from a review of the following detailed description taken in conjunction with the drawings.

### BRIEF DESCRIPTION OF THE DRAWINGS

FIG. 1 is a perspective view of a central processing unit (CPU) of the present invention;

FIG. 2 is a top plan view of the switch box used within the computer system of the present invention;

FIG. 3 is a side cutaway plan view of the internal components of the central processing unit of the present invention;

FIG. 4 is a side view illustrating the connectors within a preferred switch box of the present invention;

FIG. 5 is a side view illustrating the connectors of a traditional hard drive;

FIG. 6 is a rear view of the switch box of the present invention including signal cables and power cables which mate to a controlled memory storage device;

FIG. 7 is an exploded perspective view illustrating a preferred construction for rerouting the interrupt channel from the processor to the memory storage device through a signal switch;

FIG. 8 is a perspective view illustrating a preferred construction for rerouting the interrupt channel from the processor to the memory storage device through a signal switch;

FIG. 9 is a side cutaway view illustrating a computer housing of the present invention including a switch box connected to memory storage devices by power cables and signal cables;

FIG. 10 is a side cutaway view illustrating a computer housing of the present invention including a rear bracket assembly and external switch controlling access to a network, power to hard drive 1 and signals to hard drive 2;

FIG. 11 is a side cutaway view illustrating a computer housing of the present invention including a rear bracket assembly and front mounted internal switch controlling access to a network, power to hard drive 1 and signals to hard drive 2;

FIG. 12 is a circuit diagram illustrating the present invention including a rear bracket assembly and switch controlling access to a network, power to hard drive 1 and signals to hard drive 2;

FIG. 13 is a top view of a rear bracket assembly for controlling access to a network, power to hard drive 1 and signals to hard drive 2;

FIG. 14 is a rear view of a rear bracket assembly for controlling access to a network, power to hard drive 1 and signals to hard drive 2;

FIG. 15 is a rear view of a computer housing illustrating a rear bracket assembly and external switch for controlling access to a network, power to hard drive 1 and signals to hard drive 2;

FIG. 16 is a side cutaway view illustrating a computer housing of the present invention including a rear bracket switch assembly and an external switch box;

FIG. 17 is a side cutaway view illustrating a computer housing of the present invention including a rear bracket switch assembly and a front mounted switch box;

FIG. 18A is a circuit diagram illustrating the computer switch assembly and switch box of present invention shown in FIG. 16 wherein the switch assembly is configured in a first “in” position and the switch box is configured in a first “in” position;

FIG. 18B is a circuit diagram illustrating the computer switch assembly and switch box of the present invention shown in FIG. 16 wherein the switch assembly is configured in a second “out” position and the switch box is configured in a second “out” position;

FIG. 18C is a circuit diagram illustrating the computer switch assembly and switch box of the present invention shown in FIG. 16 wherein the switch assembly is configured in a first “in” position and the switch box is configured in a second “out” position;

FIG. 18D is a circuit diagram illustrating the computer switch assembly and switch box of the present invention shown in FIG. 16 wherein the switch assembly is configured in a second “out” position and the switch box is configured in a first “in” position;

FIG. 19 is a top view of a rear bracket assembly of the present invention;

FIG. 20 is a rear view of the bracket assembly shown in FIG. 19; and

FIG. 21 is a rear view of a computer housing illustrating a rear bracket switch assembly and an external switch box;

FIG. 22A is a circuit diagram illustrating an additional embodiment of the computer switch assembly configured in a first “in” position;

FIG. 22B is a circuit diagram illustrating an additional embodiment of the computer switch assembly configured in a second “out” position; and

FIG. 23 is a rear view of a computer housing illustrating a rear bracket switch assembly and an external switch box having two interface peripheral ports.

### DETAILED DESCRIPTION OF THE INVENTION

While the present invention is susceptible to the embodiment in various forms, as shown in the drawings, hereinafter will be described the presently preferred embodiments of the invention with the understanding that the present disclosure is to be considered as a exemplification of the invention and is not intended to limit the invention to the specific embodiments illustrated.

The computer system of the present invention includes the traditional components typically found within the ubiquitous personal computer system. With reference to the figures, the computer system includes a housing 32 for containing various components. These components include a power supply 33, a central processing unit 35, also commonly referred to as a motherboard 35, and numerous memory storage devices. As shown in the figures, these memory storage devices include CD-ROMs 37, hard drives 39 and 41, or additional units such as Zip drives, floppy drives, memory cards, memory sticks, etc. The computer system also contains various cables for connecting the power supply to the various units and signal cables for connecting memory devices to the processor. Not shown in the figures, the computer system includes a monitor and one or more tactile input devices such as a keyboard, mouse, video camera, gaming joystick, etc. Though not described herein, the computer system of the present invention may include alternative memory storage devices or alternative tactile input devices without departing from the spirit and scope of the invention.

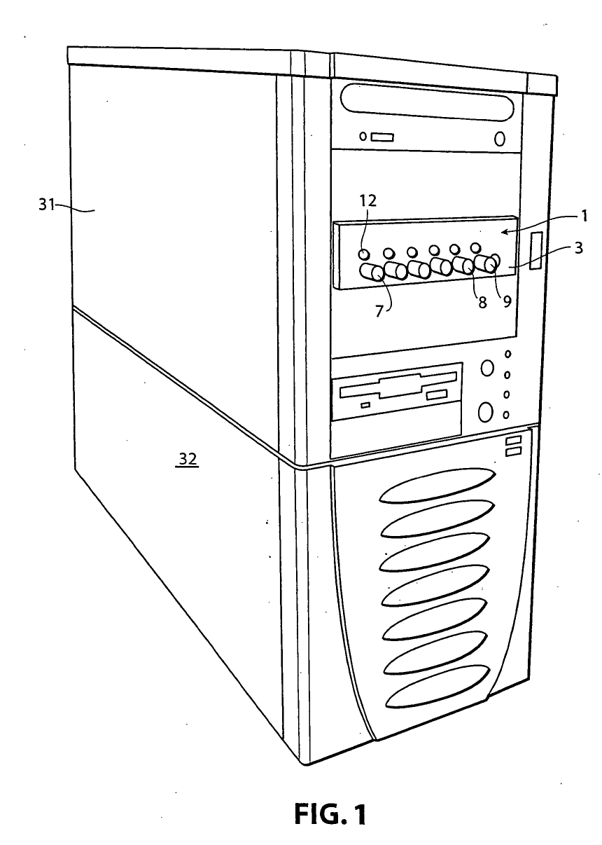

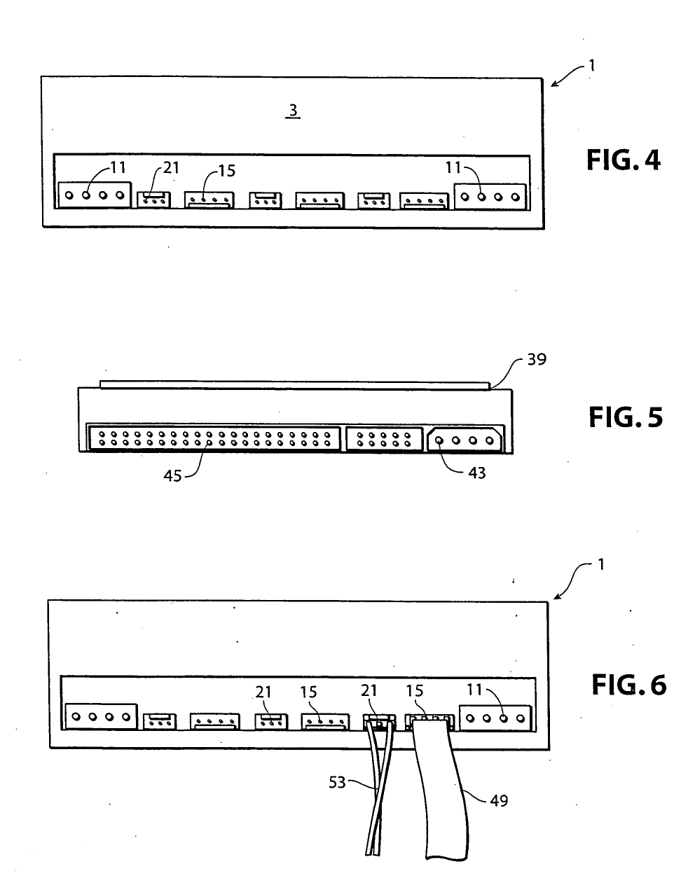

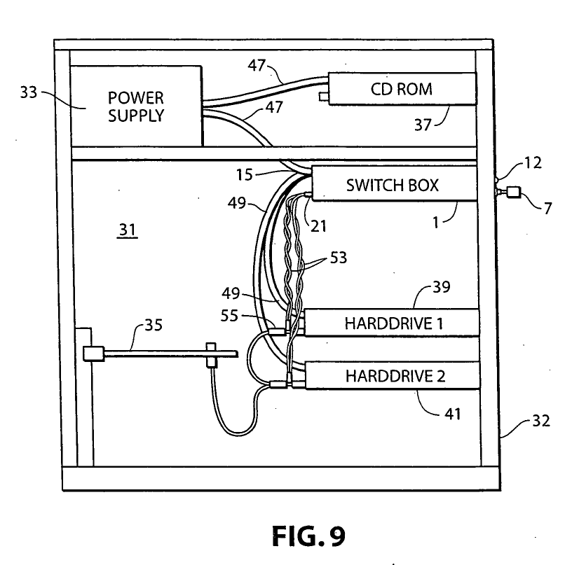

In addition to the traditional components found within a computer system, the computer system of the present invention includes a switch box 1. With a reference to FIGS. 1-9, a preferred switch box 1 includes a housing 3 constructed to be positioned within one of the plurality of bays formed in the computer's housing for mounting externally accessible peripherals.

In operation, the switch box 1 of the present invention controls the operation of one or more memory storage devices which are electrically connected to the switch box. To this end, the switch box 1 includes a plurality of manual on/off switches 7 for selectively creating an electrically open condition or closed condition. As shown in the figures, in a preferred embodiment, the switches are push button on/off switches. However, the switches may be rotary, toggle or other type of switch without departing from the spirit and scope of the invention. Moreover, the switch box may include lights, such as LEDs 12 for indicating the open or closed condition of a corresponding switch.

As shown in the 1-9, in a preferred embodiment the switch box includes a total of six switches for controlling the operation of up to three memory storage devices. The six switches are separated into three pairs of switches with each pair including a power switch 8 and a signal switch 9. The power switch controls the corresponding power to a memory storage device, while the signal switch 9 controls the transmission of data signals to and from the memory storage device. Selective operation of these signal switches enables a computer user to deactivate the memory storage device while maintaining the power to the memory storage device by simply deactivating a corresponding signal switch 9. Meanwhile, entire operation of the memory storage device can be disabled by eliminating all power to the unit using a corresponding power switch 8.

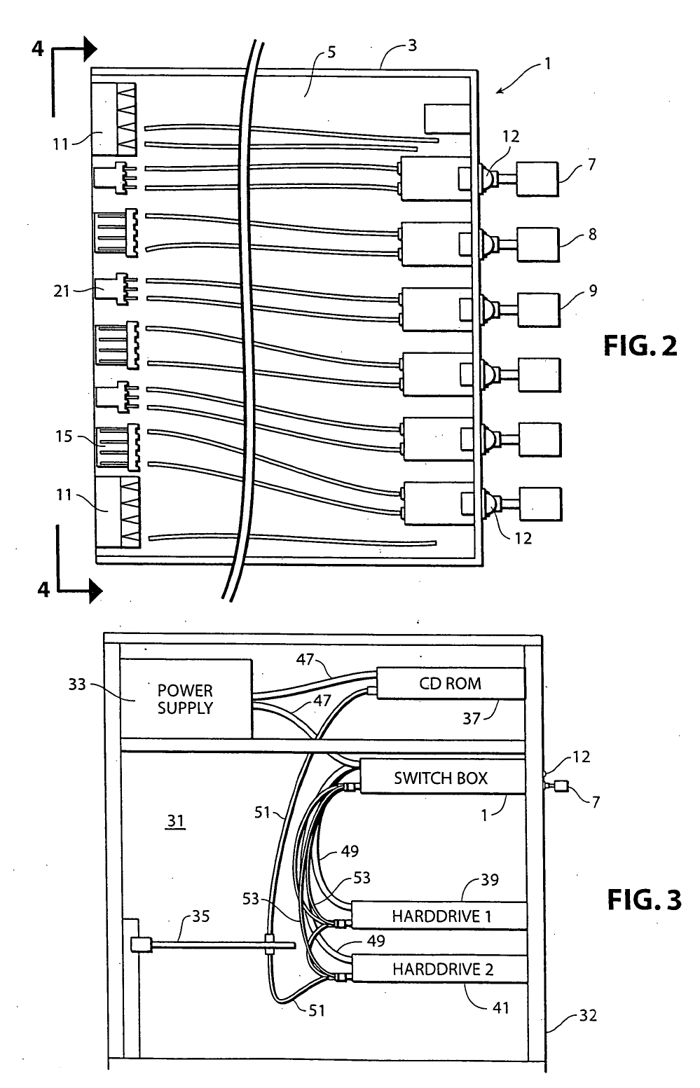

For simplicity, the memory storage devices will primarily be made reference to hereinafter as a hard drive, though alternative memory storage devices may be just as easily used with the switch box of the present invention. With reference to FIG. 3, in a preferred embodiment, the power supply does not supply power directly to the hard drive as traditionally constructed. Instead, the switch box of the present invention includes a power cable 47 which directs power to the switch box's input power connectors 11. Preferably, the power cable 47 includes four wires including a 12 volt, 5 volt and 2 ground. With reference to FIG. 2, the 12 volt, 5 volt and ground paths are then electrically connected to the power switches 8. The power switches 8 provide a selective open and close condition to all four electrical paths before directing these electrical paths to output power connectors 15. As shown in the figures, preferably the switch box includes a pair of input power connectors 11 to provide redundancy. However, these input power 5 connectors then split the individual power and ground paths into three sets of corresponding output power channels for redirection to memory storage devices, such as hard drives 39 and 41. The redirection of power from the switch box to the hard drive is accomplished by using four wire power harnesses 49. In operation, power from the power supply to the hard drive can be selectively activated and deactivated using a corresponding push button switch 8. For example, where the hard drive 1 has been electrically connected to the power supply through the left hand switch of the switch box, the hard drive 1 can be completely disabled by removing all power to the hard drive by placing switch one in an open condition. The hard drive can then be “rebooted” by providing power to the hard drive by placing the left hand switch in a closed position. Additional hard drives can be activated and deactivated using alternate switches provided within the switch box.

There are numerous instances where computer users may wish to deactivate access to a memory storage device, such as a hard drive, without completely deactivating power to the unit which requires lengthy reboot procedures at a later time. To provide security to the memory storage device without requiring the disablement of power to the unit, the switch box of the present invention further includes one or more signal switches 9 which are provided for selectively activating or deactivating the electrical signal paths from the processor to the memory storage device.

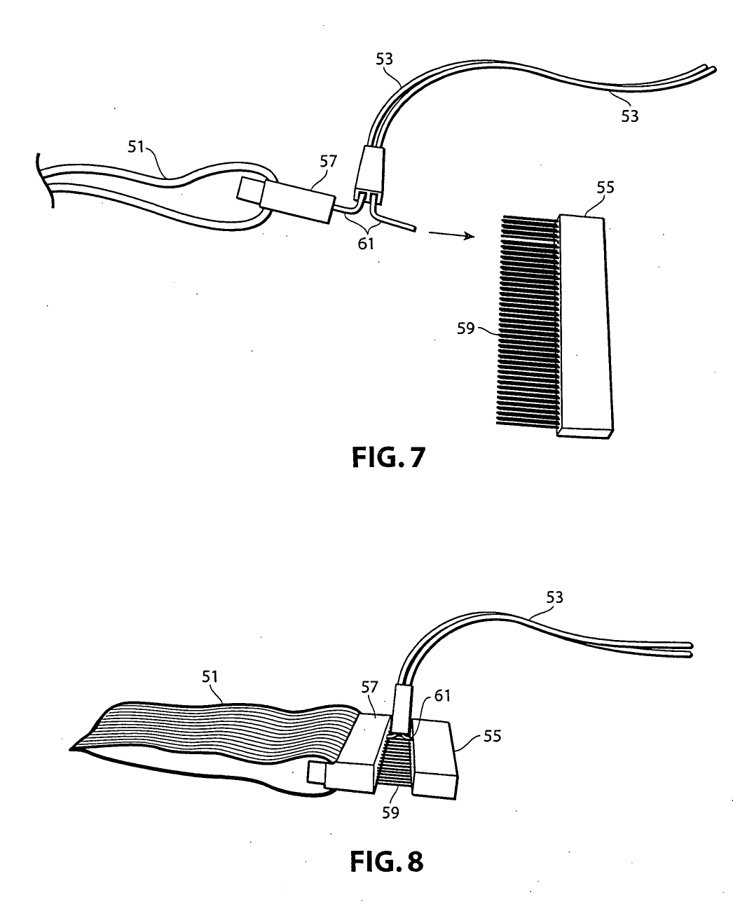

In a preferred embodiment, the computer system includes a traditional data cable 51 which connects the processor 35 to one or more hard drives 39 and 41, or other memory storage devices. However, preferably the interrupt signal, typically provided through a pin 31, in a traditional IDE cable, is rerouted to pass through a controlling signal switch 9. The traditional signal path from the processor 35 to the hard drive 39 or 41 may be rerouted at any point between the two units. However, in a preferred embodiment, illustrated in FIGS. 7-9, the interrupt signal is rerouted from the IDE cable adjacent to the memory storage device. To this end, the computer system includes an additional interrupt connector 55 having a plurality of electrically conductive pins 59 for providing direct signal paths to and from the IDE cable 51 into the memory storage device 39 and 41. However, the computer system of the present invention further includes modified pins 61 for rerouting the interrupt channel into signal wires 53 which lead to the switch box 1 of the present invention. The signal wires 53 electrically connect to a signal switch 9 which selectively provides an open or closed circuit. With the switch in a closed circuit, the processor is capable of sending signals through the interrupt channel to the memory storage device. However, when the signal switch 9 is placed in an open condition, the computer processor 35 is incapable of transmitting commands to the memory storage device thereby making the memory storage device incapable of storing information or transmitting information. In other words, placing the signal switch 9 in an open condition disables the memory storage device completely without removing power from the unit.

As shown in FIGS. 7-9, the rerouting of the interrupt channel may be accomplished using the combination of an intermediate connector and separate modified pins and signal cable 53. This construction is considered preferable when using preexisting data cables provided between the processor 35 and memory storage device. With reference to FIG. 3, in an alternative construction the IDE cable 51 is constructed to include signal wires 53 for mating to the switch box's signal connectors 21.

Any number of memory storage devices can be controlled using the switch box of the present invention. As shown in the figures, a preferred switch box includes six switches for controlling the power and signal operation of three memory storage devices. However, any number of buttons may be included in the switch box for controlling any number of memory storage devices. In addition, the computer system may be wired to control some but not all memory storage devices. For example, as shown in FIG. 3, in a preferred construction the hard drive 1 and 2 is electrically connected to the switch box so that the power and operation of the unit can be selectively activated or deactivated. However, the CD-ROM 37 is not connected to the switch box. Thus, the CD-ROM is incapable of being activated or deactivated in accordance with the present invention. Notwithstanding, the computer user may connect the CD-ROM to the switch box if additional security is desired.

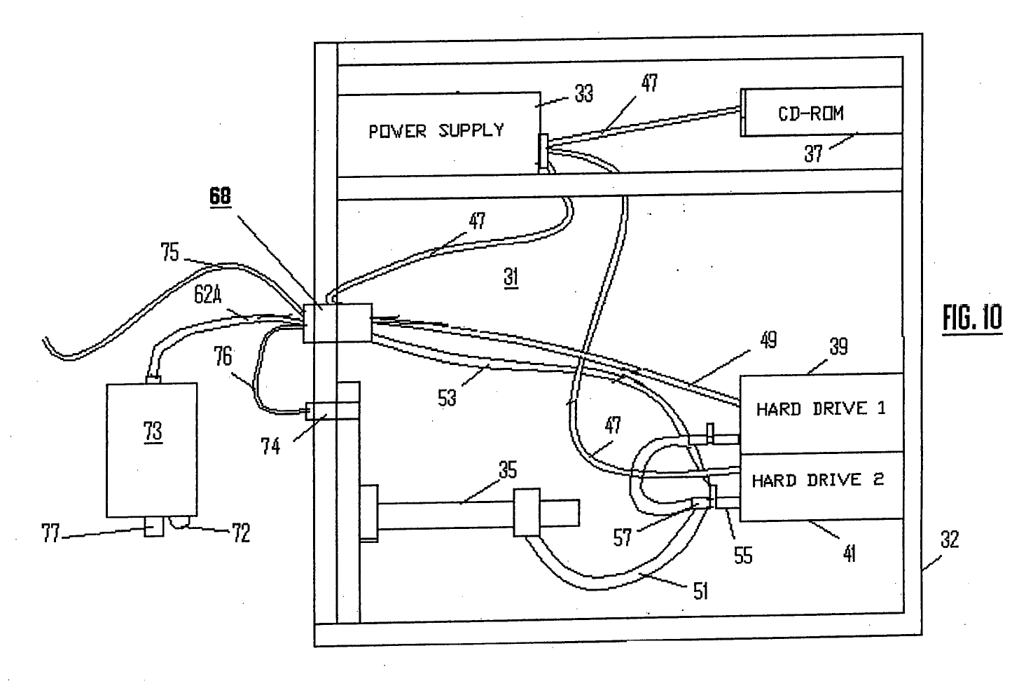

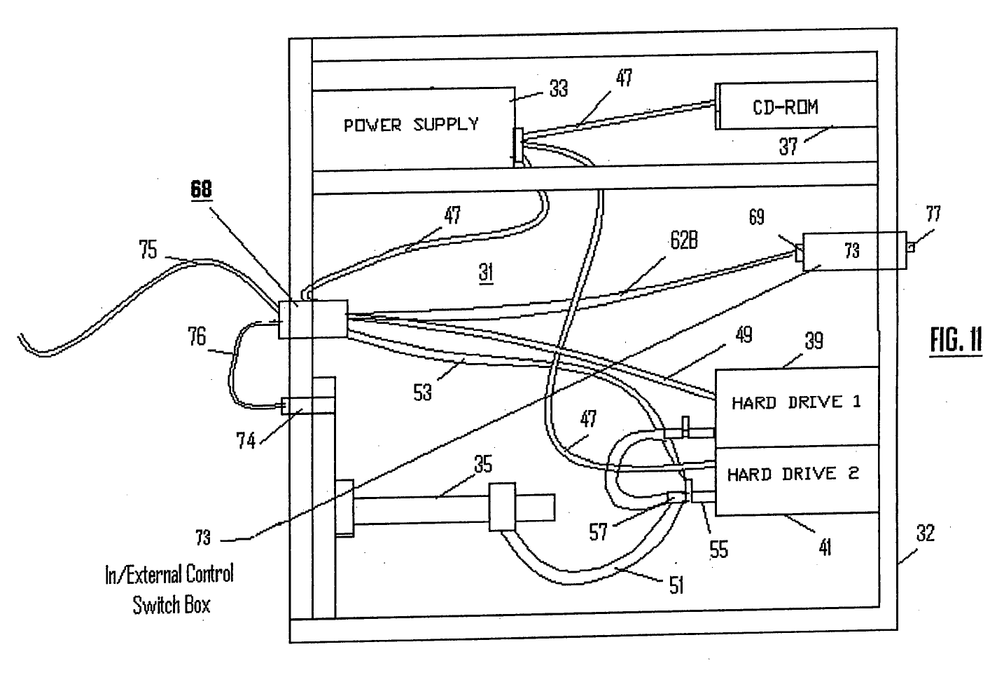

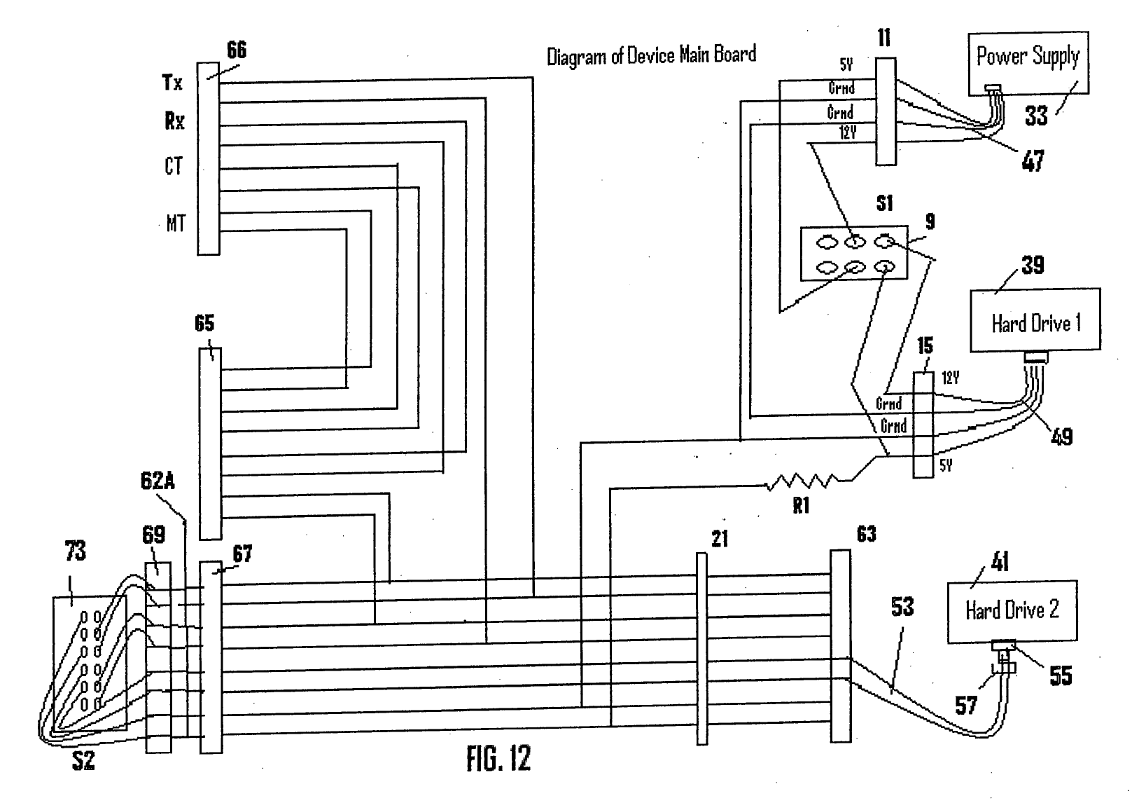

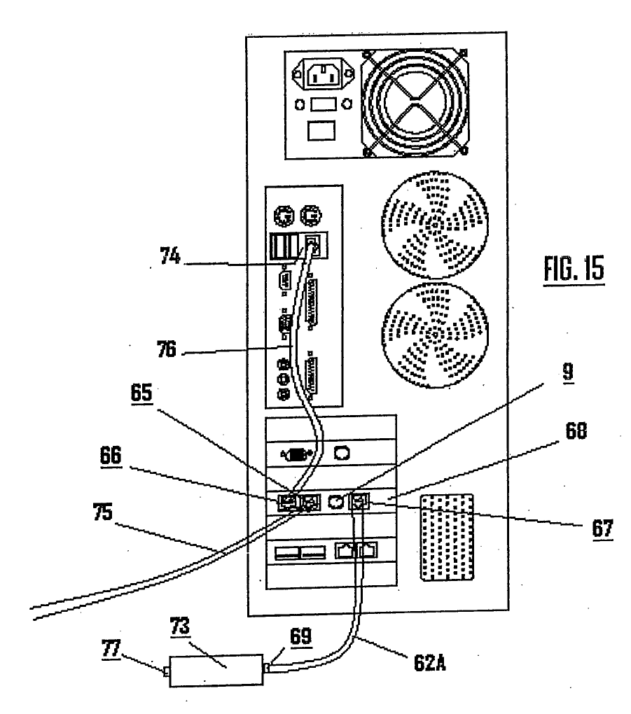

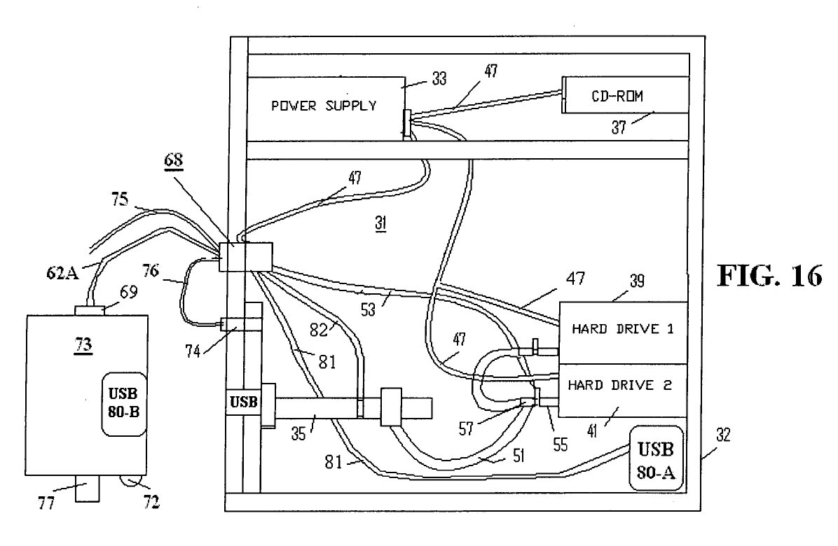

With reference to FIGS. 10-15, in addition to a subsystem for controlling the power and signals to a hard drive, the computer system of the present invention preferably includes a switching system for controlling the connection between a network, such as a LAN, WAN or Internet network, with the computer's central processing unit.

With reference particularly to FIGS. 12-14, the computer system includes a network port 74 located on the rear of the computer's housing which may be a traditional female connector electrically coupled to the computer's network card. Moreover, the computer system of the present invention includes a bracket assembly 68 forming a portion of the rear of the computer's housing. The bracket assembly 68 includes an input port 65 and an output port 67. Both the input port and output port form part of the bracket assembly 68 mounted upon the housing's exterior and preferably are positioned to face exterior to the computer's housing so as to be easily accessible. The input port and output port are electrically coupled except for an intermediate switch 73 which selectively provides an open circuit or closed circuit for permitting or disabling the electrical connection between the input port 65 and output port 67.

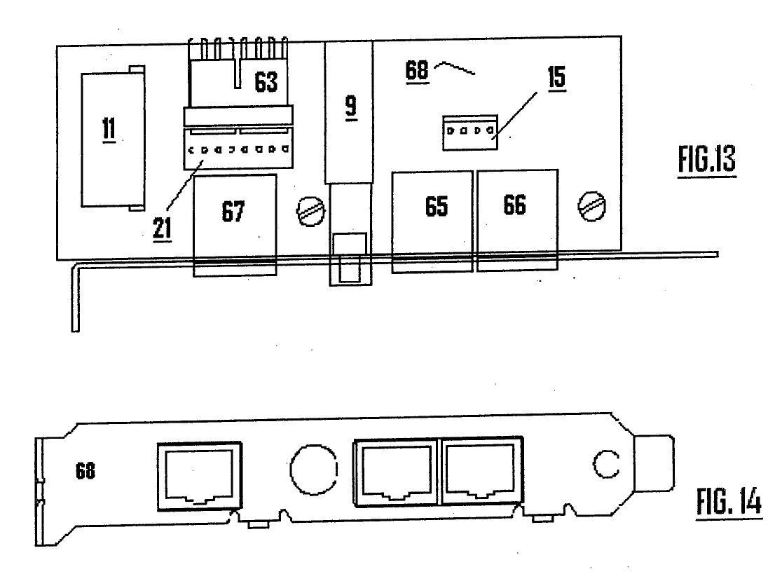

The intermediate switch 73 is preferably a manual controller, including a toggle, knob or button, and which may be located either upon the computer's housing or exterior to the computer's housing. As shown in FIGS. 10, 13 and 15, in a first embodiment, the bracket assembly 68 includes a “switch” port 67 for connecting to a switch cable 62A traveling to an exterior switch 73. Signals traveling from the bracket assembly's input port 65 are routed exterior to the computer's housing to the switch 73 and then routed back through the switch cable 62A to the bracket assembly's output port 66. With reference to FIG. 11, alternatively the switch 73 may be mounted to the computer's housing with the manual lever, button or other manipulated device 77 being accessible exterior to the housing. For this embodiment, signals traveling from the bracket assembly's input port 65 are routed interior to the computer's housing to the switch 73 and then routed back through the cable 62B to the bracket assembly's output port 66.

In addition, the switching system includes additional wire harnesses including a network cable 75 connecting a network to the bracket assembly's input port 65 and a relay cable 76 for connecting the bracket assembly's output port 66 to the computer's network port 74. Instead of network communications being transmitted directly from the network to the network port, the signals are rerouted through the bracket assembly's input port 65, manual switch 73 and output port 66, and then routed to the computer's network port 74. Access to the network is then controlled by simple manual manipulation of a button, toggle or knob 77 to create an open or closed circuit, thereby enabling or disabling access by the computer to the network.

With reference to FIGS. 10-12, the manual switch 73 may also control the “interrupt” channel of a selected hard drive 41. As explained above, each hard drive can be selectively controlled by selectively enabling or disabling the transmission of the “interrupt” channel typically found on the pin 31 of an IDE cable. The signal is rerouted through a signal cable 53 to the manual switch and routed back through the signal cable 53 to the hard drive connector 55. Thus, for this embodiment of the invention, activation of the switch 73 provides an open or closed condition in the interrupt channel thereby selectively activating or deactivating a hard drive, as well as providing corresponding selective activation or deactivation of the network system.

With reference to FIGS. 12 and 13, in still an additional embodiment of the invention, the bracket assembly 68 includes an input power connector 11 for receiving power through the power cable 47 from the power supply 33 and an output power connector 15 for routing power to any one of the computer's hard drives. Cables 47 and 49 are provided for routing power to the input power connector and for transmitting the power from the bracket assembly's output power connector to the hard drive 39. Coupled intermediate to the input power connector 11 and output power connector 15, the bracket assembly 68 includes a bracket assembly power switch 9 for selectively enabling and disabling the transmission of power to a selected hard drive. The hard drive with power control may be the same hard drive selected for controlled access of data, or as shown in the drawings, the hard drive 39 with power control may be a hard drive other than the hard drive 41 having signal control.

As shown in the circuit diagram of FIG. 12, a preferred switch 73 includes four input terminals and four output terminals for providing four open or closed circuits, preferably, though not necessarily, with all circuits controlled by a single button, toggle or knob 77. A network cable often has six wires, in which transmission and receipt of information is typically controlled over only two wires designated Tx and Rx. Preferably, the non-transmit and non-receive signals are routed directly between the input port 65 and output port 66. Meanwhile, the Tx and Rx signals are routed from the input connector 65 through the switch 73 to the output connector 66. Upon the switch making a closed circuit, the network is accessible to the computer processor 35, while an open circuit makes the network inaccessible. In addition, in a preferred embodiment, the switch 73 includes input and output terminals dedicated to transmitting the “interrupt” signal through a cable 53 to a dedicated hard drive 41. Finally, the switch's remaining input and output terminals are preferably dedicated to power and ground for illuminating an LED indicator 72 located on the switch 73. The LED indicator provides a visual indication of the status of the button, toggle, or knob 77, the corresponding open or closed condition of the switch 73, and the corresponding enabled or disabled condition of the network and hard drive.

Still with reference to FIG. 12, but also FIGS. 10-15, the computer system preferably includes a manual power switch 9 for controlling power to a hard drive 39. The manual power switch may be located external to the computer housing (not shown). However, the manual power switch 9 is preferably located as part of the bracket assembly 68. Power is transmitted from the power supply 33 through the cable 47 to the switch 9. The switch 9 provides an open or closed circuit to supply or disable power to the hard drive 39 through output terminals 15 and the power cable 49.

Where the computer system of the present invention includes a manual switch 73 that controls signals to both a network and hard drive, and a bracket assembly switch 9 for controlling power to a hard drive, the switch box 1 of the present invention may not be needed. For example, where the computer user does not require control of multiple drives, such as where sensitive data and network use is limited to a single hard drive, signal control and power control of an alternate hard drive may not be required. In such a circumstance, the switch box of the present invention for controlling signal and power of multiple hard drives may be eliminated.

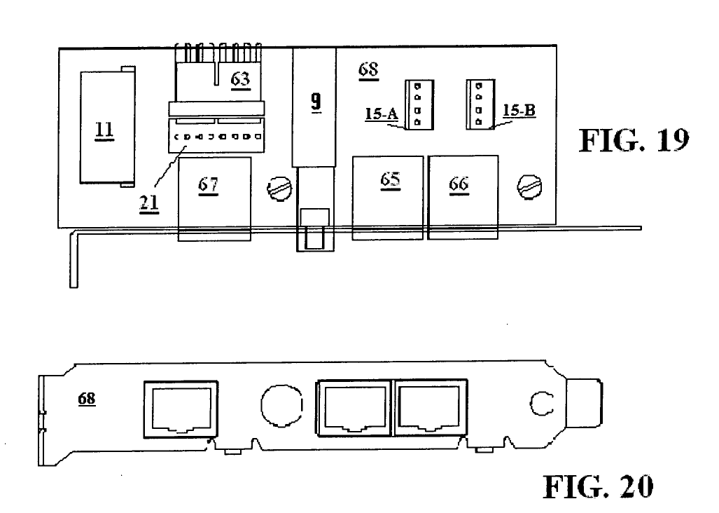

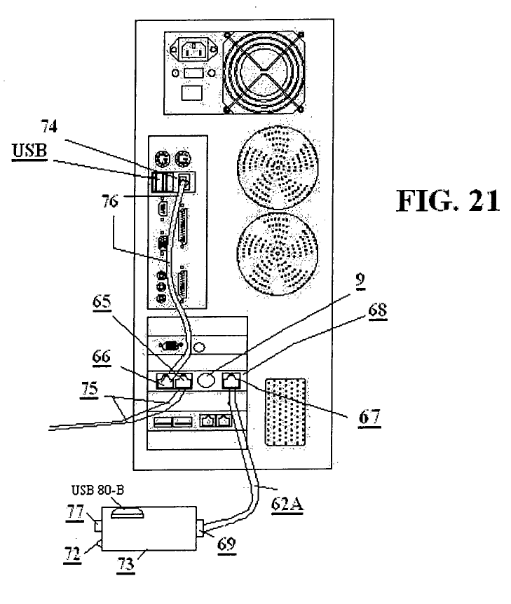

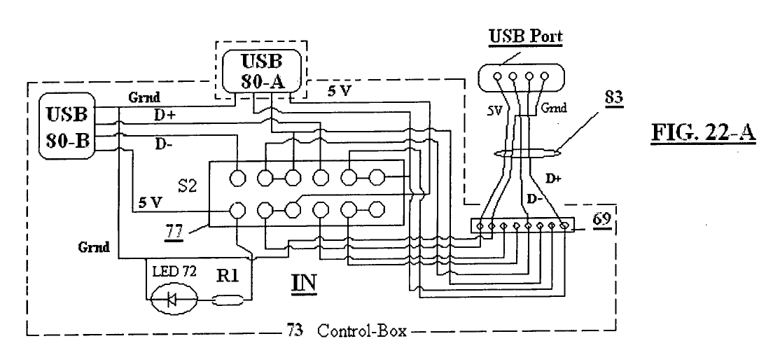

With reference to FIGS. 16-21, the switching apparatus of the present invention can also be used to control a computer's interface to interface peripheral devices such as convention USB (“Universal Serial Bus”) ports. In a preferred embodiment shown in FIG. 16, the computer includes a power supply 33, a processor 35, memory devices in the form of a CD-ROM 37, a first hard drive 39 and a second hard drive 41, a front mounted USB port 80-A, and a rear mounted USB port 80-B.

The computer system of the present invention further includes switching components which, for simplicity and to differentiate between other switching apparatus described herein, are identified as switch assembly 68 and a switch box 77. The switch assembly 68 includes a plurality of internal switches which may by controlled by a single Four Pole Double Throw (FPDT) switch controller 9. With reference to FIGS. 16-20, the switch controller 9 includes internal switching components for selectively connecting and disconnecting the transmission of data signals referred to as D+ and D− to and from the interface peripheral port 80-A, which is preferably a Universal Serial Bus (“USB”) port. To control the transmission of data to and from the central processor to USB 80-A, the computer system includes a cable 82 which relays data between the central processor unit 35 and switch assembly 68. Data through D+ and D− circuits is then selectively transmitted through the switch controller 9 and cable 81 to USB 80-A. By providing an open or closed circuit condition between the central processing unit 35 and USB port 80-A, any peripheral devises connected to the port, such as wireless networking transceivers, can be activated and deactivated.

The switch controller 9 also includes internal switching components for selectively connecting and disconnecting the network to the computer's central processing unit. Selective activation and deactivation of the network is accomplished in similar manner as illustrated in FIGS. 12-14. For this embodiment, illustrated in FIGS. 16-21, the computer system includes a network port 74 located on the rear of the computer's housing which may be a traditional female connector electrically coupled to the computer's network card. Moreover, the computer system preferably includes an additional bracket assembly 68 forming a portion of the rear of the computer's housing. The bracket assembly 68 includes an input port 65 and an output port 66. Both the input port and output port form part of the bracket assembly 68 mounted upon the housing exterior and are positioned to face exterior to the computer's housing so as to be easily accessible. The input port and output port are electrically coupled. However, intermediate switch 9 within switch assembly 68 selectively provides an open circuit or closed circuit for permitting or disabling the electrical connection between the input port 65 and output port 67.

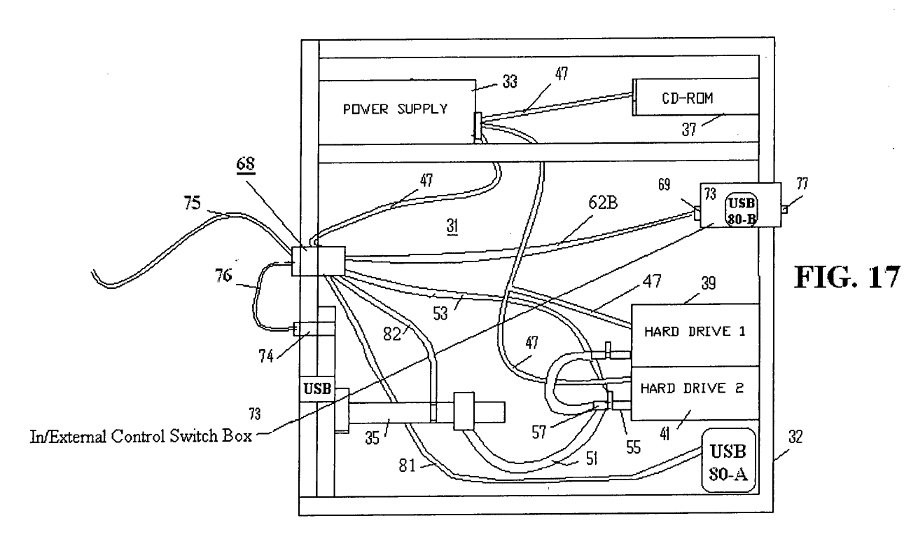

The preferred embodiment shown in FIGS. 16-21 also includes switch components which, for purposes of differentiating from the various switch components described above, is identified as a switch box 77. The preferred embodiments illustrate the switch box being external to the computer's housing. However, unless explicitly stated, the term “switch box” is intended to have a broad meaning of a switching apparatus that may be positioned interior or exterior to the computer housing. For example, FIG. 16 illustrates an external switch box 77, while FIG. 17 illustrates an internally mounted switch box. The switch box 77 preferably includes three switches identified as a control switch, a peripheral switch and a network switch. In a preferred embodiment, all three switches are incorporated in a single Four Pole Double Throw (FPDT) switch controller.

The control switch controls activation and deactivation of the hard drive 41. In similar manner as described with reference to FIGS. 7-11, the control signals of the hard drive 41 are selectively interrupted. With reference to FIGS. 7 and 16-21, the control signals, typically provided through pin 31 in a traditional IDE cable, are rerouted to pass through a control switch 77. The computer system includes an additional interrupt connector 55 having a plurality of electrically conductive pins 59 for providing direct signal paths to and from the IDE cable 51 into the memory storage device 39 and 41. However, the computer system of the present invention further includes modified pins for rerouting the interrupt channel into signal wires 53 which lead to the switch box 77 of the present invention. The signal wires 53 electrically connect to the control switch which selectively provides an open or closed circuit. With the control switch in a closed circuit, the processor is capable of sending signals through the interrupt channel to the memory storage device. However, when the control switch within the switch box 77 is placed in an open condition, the computer processor 35 is incapable of transmitting commands to the memory storage device thereby making the memory storage device incapable of storing information or transmitting information, and thereby disabling the memory storage device completely without removing power from the unit.

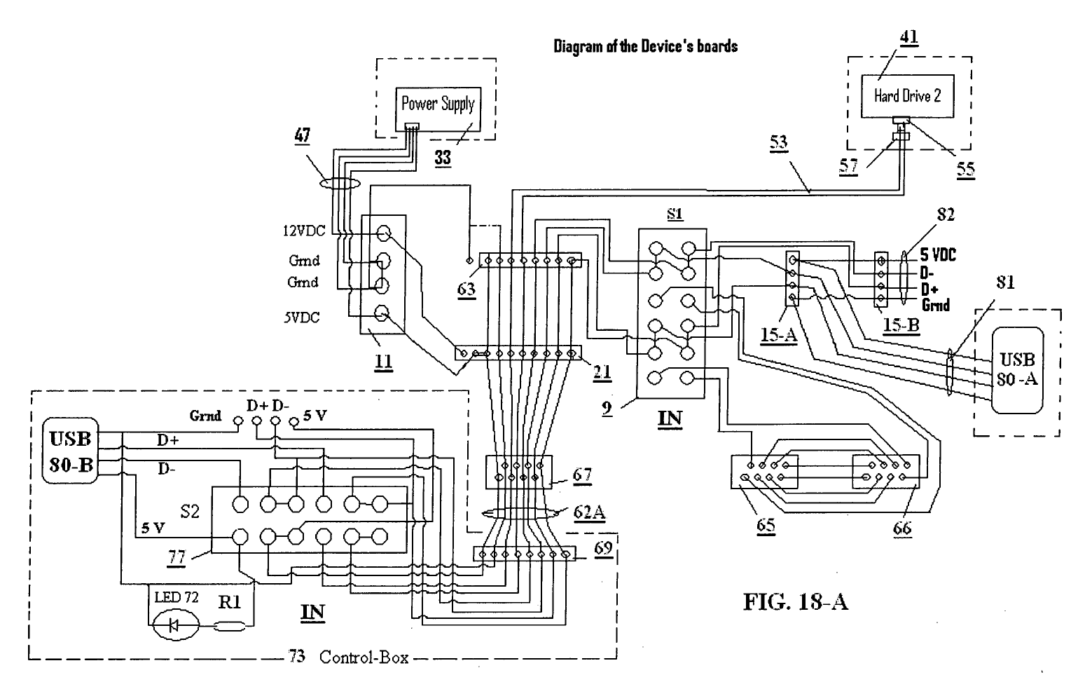

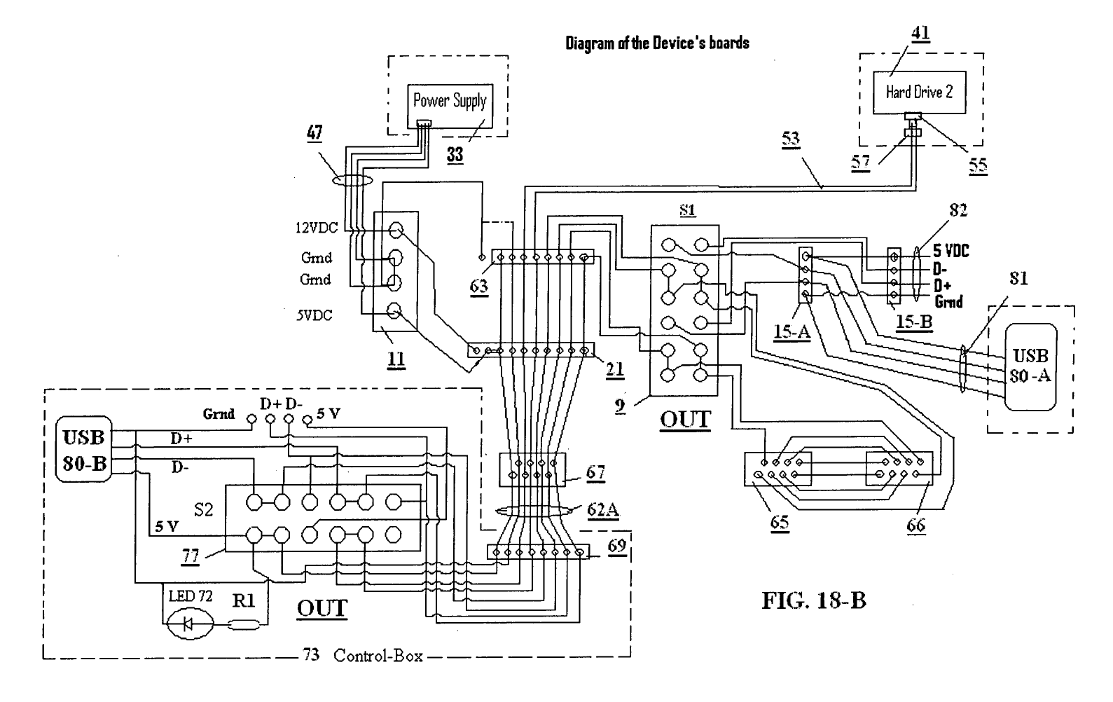

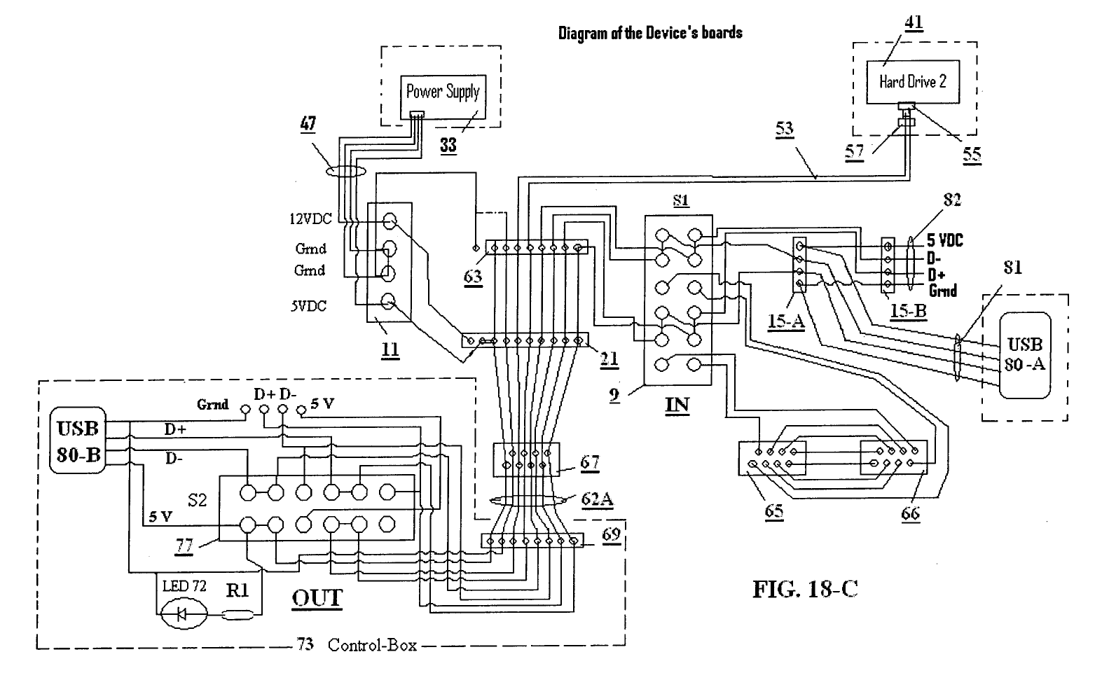

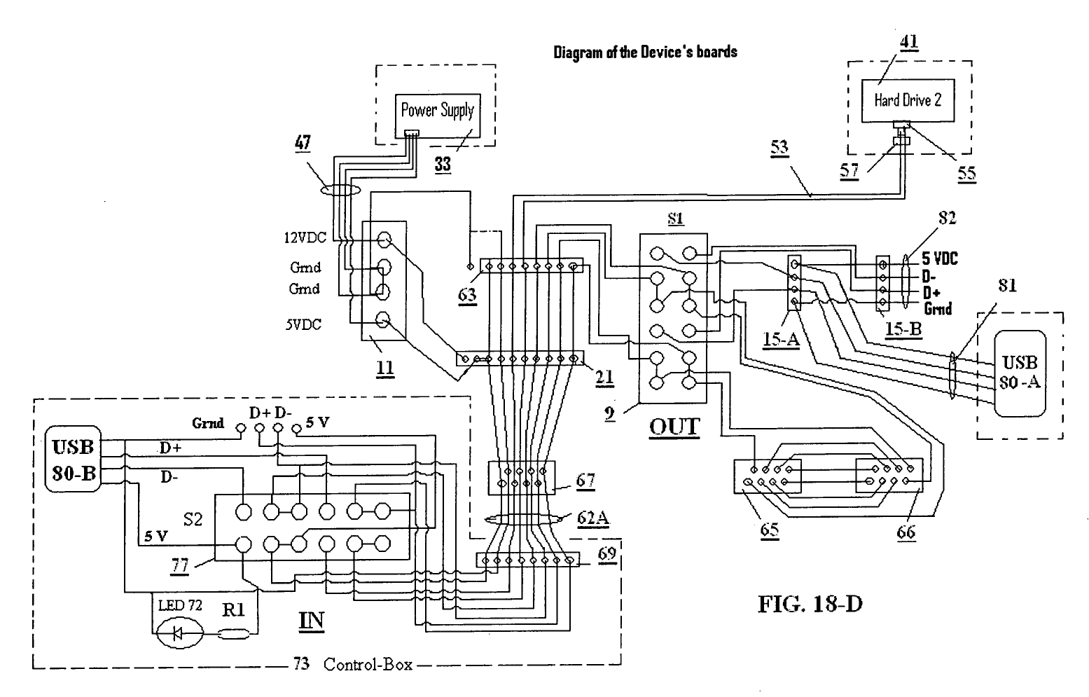

As shown in FIGS. 16 and 17, preferably the switch box includes an interface peripheral port, shown as USB 80-B, and the peripheral switch within the switch box 77 selectively activates and deactivates peripheral devices which would typically be connected to this peripheral port. Meanwhile, with reference to FIGS. 18A-18D, the peripheral switch selectively connects and disconnects the transmission of data signals between the computer's central processing unit 35 and the interface peripheral port 80-B. Data is selectively transmitted through the switch controller 77 and cable 62A, which is preferably an RJ45 cable, between the central processor 35 and USB 80-B. As shown in FIGS. 18A-18D, the data signals may be relayed through switch controller 9, or in an alternative embodiment, not shown, the data signals are routed directly to the central processing unit. By providing an open or closed circuit condition between the central processing unit and USB port 80-B, any peripherals connected to the port, including but not limited to a wireless networking transceiver, can be activated and deactivated.

The switch box's remaining Four Pole Double Throw input and output terminals are preferably dedicated to power and ground for illuminating an LED indicator 72 located on the switch box 77. The LED indicator provides a visual indication of the status of the button, toggle, or knob, and the corresponding open or closed condition of the switches, and the corresponding enabled or disabled condition of the network, hard drive and/or interface peripheral port USB 80-B.

Preferably, the network is coupled through the network switch within the switch box 77 as well as through switch controller 9 to control connection of the network to the computer's central processing unit 35. As shown in FIGS. 18D, the network signals are transmitted through the network input port 65 and through switch assembly 9 and switch box 77 before being transmitted back to the output port 66 for transmission to network port 74 through cable 76. For this embodiment, both the switch controller 9 and the network switch within the switch box 77 must be in a closed circuit condition for the network to be connected to the computer's central processing unit 35.

In the preferred embodiment shown in FIGS. 17, 18A-18D, power to USB 80A also travels through switch box 77 as well as switch assembly 9. Thus, for USB 80A to be activated, both the switch box 77 and switch assembly 9 must be in correct circuit orientation. Otherwise an open circuit will be encountered at either the switch box 77 or switch assembly 9 resulting in deactivation of USB 80A.

As illustrated in FIGS. 18A-18D, both the switch box 77 and switch assembly 9 are Four Pole Double Throw switch apparatus having “activated” or “deactivated” toggle or push button conditions, which are designated for simplicity as “in” or “out”. However, such designations are for reference only and such designations may be alternated or substituted depending on the type of switch employed. As a result of the preferred embodiment incorporating two switches with each having an activated and deactivated condition, the computer system provides four operating environments.

As shown in FIG. 18A, when both the switch box 77 and switch assembly switch 9 are positioned in a first position designated as “in”, USB 80-A is activated. Meanwhile, the network connection and USB 80-B is deactivated, and the hard drive 41 and LED 72 are disabled.

As shown in FIG. 18B, when both the switch box 77 and switch assembly switch 9 are moved to a second position designated as “out”, USB 80-A, USB 80-B, and the network cable function are disabled. Meanwhile, hard drive 41 is enabled and fully functional and LED 72 is activated.

As shown in FIG. 18C, when the switch box 77 is positioned within the “out” condition and switch assembly switch 9 is placed in the “in” condition, USB-80A and the network cable function are disabled. Meanwhile, USB-80B and hard drive 41 is enabled and fully functional, and LED 72 is activated.

Finally, as shown in FIG. 18D, when both the switch box 77 is positioned in the “in” condition and switch assembly switch 9 is positioned in the “out” condition, the network cable function are enabled. Meanwhile, USB 80-A, USB 80-B and the hard drive 41 are disabled and LED 72 is deactivated.

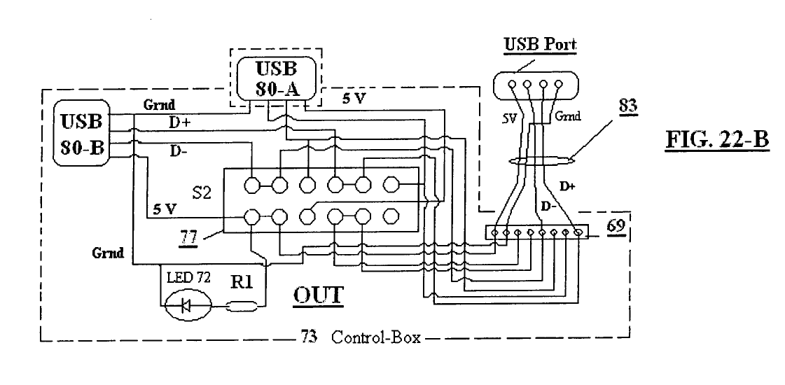

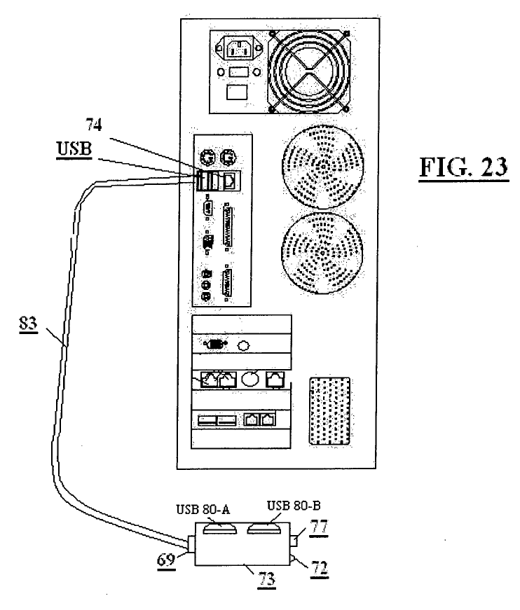

As would be understood by those skilled in the art after reading this disclosure, the switch box 77 and switch assembly 9 may be utilized independently of the other. For example, FIGS. 22-23 illustrate computer systems of the present invention incorporating a switch box 77 for controlling access to interface peripheral ports USB 80-A and 80-B without incorporating a bracket switching assembly. FIGS. 22A, 22B and 23 illustrate an embodiment wherein the switch box 77 is a Four Pole Double Throw construction capable of being utilized to simultaneously control activation and deactivate of a network, a hard drive and an interface peripheral port, as shown in FIGS. 16-21. However, as shown in FIGS. 22A, 22B and 23, the same switch 77 is being utilized to control activation and deactivation of two interface peripheral ports USB 80-A and USB 80-B. The computer system includes a modified harness cable 83 connecting the switch box's connector 69 to the computer's traditionally mounted interface peripheral port USB. Because the switch box preferably possesses a traditional RJ45 female jack, preferably the harness cable 83 includes four wires interconnecting a traditional USB plug to a modified RJ45 male plug, which typically has eight active terminals. As shown in FIG. 22A, positioning the switch box to a first condition “in” causes activation of USB 80-A, and deactivation of USB 80-B. In operation, power and data signals are transmitted between the central processing unit and USB 80-A, by transmitting power and data signals through the switch box 77, the rear mounted USB port and the modified cable 83. As shown in FIG. 22B, positioning the switch box to a second “out” condition causes deactivation of USB 80-A. Meanwhile, USB 80-B is activated and power and data signals are transmitted between the central processing unit and USB 80-B through the switch box 77, the rear mounted USB port, and the modified cable 83.

Still additional modifications of the computer system of the present system can be made without departing from the spirit and scope of the invention. For example, herein is described a particular construction for disabling a signal path from the processor to a memory storage device without disabling power to the unit. However, alternative constructions wherein different signal paths are controlled through the switch box may be adopted without departing from the scope of the present invention.

Having described my invention in such terms to enable those skilled in the art to make and use it, and having identified the presently preferred embodiments thereof, I claim:

1. A computer system comprising:
a power supply;
a central processor unit including a network card;
a memory storage device;
a housing for storing said power supply, central processing unit, and memory storage device, said housing including an interior, an exterior, a front and a back, said housing further including a network port which can be used for connecting said central processing unit directly to a network;
a bracket assembly including an input port facing exterior of said housing and an output port facing exterior to said housing;
a harness system including a network cable for connecting said network to said input port and a relay cable exterior to said housing for connecting said output port to said network port;
a manual network switch electrically connecting said input port and said output port and for selectively interrupting and connecting said network to said central processing unit;
a first interface peripheral port connected to said central processing unit; and
a manual peripheral switch for selectively connecting and disconnecting said first interface peripheral port to said central processing unit.

2. The computer system of claim 1 wherein said interface peripheral port is a USB port.

3. The computer system of claim 2 wherein said first interface peripheral port is connected to a wireless network transceiver.

4. The computer system of claim 1 wherein said manual network switch and said manual peripheral switch are controlled by a single manual controller including a first position and a second position;
said first position for electrically connecting said input port to said output port for connecting said central processing unit to a network and for simultaneously disconnecting central processing unit from said first interface peripheral port; and
said second position for disconnecting said input port from said output port for disconnecting said central processing unit from a network and for simultaneously connecting said central processing unit to said first interface peripheral port.

5. The computer system of claim 1 wherein:
said manual peripheral switch and said first interface peripheral port are located external to said housing; and
said computer system further includes a cable routed exterior to said housing for connecting said first interface peripheral port to said central processing unit.

6. The computer system of claim 1 wherein:
said memory storage device includes a plurality of electrical input and output terminals, said electrical terminals including a control terminal for receiving control signals which control recording and transmission of information into and from said memory device; and
said computer system further includes a manual control switch for selectively connecting and disconnecting said control terminal to said central processing unit;
said manual control switch having a first position allowing control signals to be transmitted from said central processing unit to said memory storage device, and a second position for preventing control signals to be transmitted from said central processing unit to said memory storage device.

7. The computer system of claim 6 wherein:
said manual network switch, said manual peripheral switch and said manual control switch are controlled by a single manual controller, the manual controller including a first position and a second position;
said first position for connecting said input port to said output port for connecting said central processing unit to a network, and for simultaneously connecting said first interface peripheral port to said central processing unit, and for simultaneously preventing control signals to be transmitted from said central processing unit to said memory storage device; and
said second position for disconnecting said input port to said output port for disconnecting said central processing unit from a network and for simultaneously disconnecting said first interface peripheral port to said central processing unit, and for simultaneously permitting control signals to be transmitted from said central processing unit to said memory storage device.

8. The computer system of claim 6 wherein said interface peripheral ports are USB ports.

9. A computer system:
a power supply;
a central processing unit including a network card;
a memory storage device;
a housing for storing said power supply, central processing unit, and memory storage device, said housing further including a network port which can be used for connecting said central processing unit directly to a network;
a bracket assembly including an input port facing exterior of said housing and an output port facing exterior to a said housing;
a harness system including a network cable for connecting the network to said input port and a relay cable exterior to said housing for connecting said output port to said network port;
a first interface peripheral port;
a manual switch controller for selectively connecting and disconnecting said input port and said output port and for selectively connecting and for selectively disconnecting said interface peripheral port to said power supply; and
said manual switch controller having a first position for simultaneously disconnecting said first interface peripheral port from said central processing unit while connecting said input port to said output port to connect said central processing unit to a network, and a second position for connecting said first interface peripheral port with said central processing unit while simultaneously disconnecting said input port to said output port to disconnect said central processing unit from a network

10. A computer system comprising of claim 9 further comprising:
a second interface peripheral port; and
a manual peripheral switch electrically connecting and disconnecting said second interface peripheral port to said central processing unit.

11. The computer system of claim 10 wherein said interface peripheral ports are USB ports.

12. A computer system comprising:
a power supply;
a central processor unit;
a memory storage device;
a housing for storing said power supply, central processing unit, and memory storage device, said housing including an interior, an exterior, a front and a back;
a first interface peripheral port connected to said central processing unit; and
a manual peripheral switch electrically connecting and disconnecting said first interface peripheral port to said central processing unit, said manual peripheral switch and first interface peripheral port are located external to said housing; and
a cable routed exterior to said housing for connecting said manual peripheral switch to said central processing unit.

13. The computer system of claim 12 further comprising:
a second interface peripheral switch located external to said housing and connected to said manual peripheral switch;
a third interface peripheral port connected to said central processing unit and forming a part of said housing;
said first, second and third interface peripheral ports are USB ports;
and said manual peripheral switch is connected to said third peripheral switch through a cable having an RJ45 male plug electrically connected to a USB plug, said manual peripheral switch is a four pole double throw switching component for alternatively connecting and disconnecting either the first or second interface peripheral port to said third interface peripheral port.

14. The computer system of claim 12 further comprising:
second interface peripheral port connected to said manual peripheral switch and which is exterior to said housing and a third interface peripheral port connected to said central processing unit and forming a part of said housing;
said manual peripheral switch connected to said third peripheral port by said cable; and
said manual peripheral switch possesses two switching conditions for alternatively connecting or disconnecting said first or second peripheral port to said third interface peripheral port.

15. The computer system of claim 14 wherein said manual peripheral switch is a four pole double throw switching component, said interface peripheral ports are USB ports, and said manual peripheral switch is connected to said first USB port through a cable having an RJ45 male plug electrically connected to a USB plug.
